(19) United States
(12) Patent Application Publication
(10) Pub. No.: US 2021/0354324 A1
(43) Pub. Date: Nov. 18, 2021

(54) ERGONOMIC DISPOSABLE CUTTING TOOL FOR STERILITY TESTING

(71) Applicant: Merck Patent GmbH, Darmstadt (DE)

(72) Inventors: Gerard MULLER, Urmatt (FR); Mathieu ARRAULT, Dabo (FR); Julien BOEUF, Barr (FR)

(73) Assignee: Merck Patent GmbH, Darmstadt (DE)

(21) Appl. No.: 16/606,305

(22) PCT Filed: Apr. 16, 2018
(86) PCT No.: PCT/EP2018/059695

§ 371 Date: Oct. 18, 2019

(30) Foreign Application Priority Data
Apr. 20, 2017 (EP) 17290054.0

(51) Int. Cl. B26D 3/16; B26D 5/10

(52) U.S. Cl. CPC B26D 3/169; B26D 5/10

(57) ABSTRACT

The invention relates to a device for cutting tubing, comprising a frame having an entry window and an exit window for defining a pathway of the longitudinal axis of the tube through the device, a cutting element arranged on the frame, wherein the cutting element is arranged lateral and opposite to the pathway of the tubing and wherein at least the portion of the frame is formed mobile and the cutting element is arranged on or opposite to the mobile portion to enable the cutting element to be pressed into the pathway of the longitudinal axis of the tubing.

### FIELD OF INVENTION

The invention relates to a disposable cutting tool for cutting in particular flexible tubing which are for example used in sterile media delivery.

### BACKGROUND OF THE INVENTION

Tubings, which are small tubes, pipes or hoses, are used in the handling sterile media, for example to distribute sterile media from container bags into vials or bottles. After use, these tubings are cut and closed with clamping devices. Often, the applications are carried out in a sterilized isolated chamber with very restricted space. The actions in the chamber have to be handled with gloves that restrict the ability to work precisely with the hands. Cutting the tubings with scissors is therefore cumbersome and difficult. Additionally, there is the risk of glove damage and if you forget to load the scissors in the isolator, it is necessary to start again a full process of the sterilization of the isolator chamber.

### DISCLOSURE OF THE INVENTION

The object of the invention is therefore to provide an easy and convenient way to cut tubings in restricted space without having the danger of damaging equipment. This object is achieved by a device for cutting tubing according to claim 1.

An inventive device for cutting tubing, in particular flexible tubing, comprises a frame, which is in particular loop-wise formed, having an entry window and an exit window for defining a pathway of the longitudinal axis of the tubing through the device, a cutting element arranged on the frame, wherein the cutting element is arranged lateral and opposite to the pathway of the tube and wherein at least a portion of the frame is formed mobile and the cutting element is arranged on or opposite to the mobile portion to enable the cutting element to be pressed into the pathway of the longitudinal axis of the tube. Since the cutting element is provided inside the frame that accommodates a portion of the tubing and cutting is performed by simply pressing the mobile portion, it is not necessary to provide additional tools in the isolated chamber and cutting the tubing is easy, comfortable and risk free.

Preferably, the cutting element is a metal blade. A metal blade is cheap, but provides a clean and secure cut of the tubing. The cutting element can also be made from ceramic which is very durable, or of plastics, in particular of the same plastic material as the frame, which is cheap and easier to manufacture. The cutting element is preferably accommodated by the frame, for example glued into a corresponding reception, moulded into the frame or pushed into a respective reception.

To increase the safety of the cutting device, the frame can further comprise protective walls for covering the cutting element before, during and/or after cutting.

The frame may further comprise a support having at least one, preferably at least two protrusions. Even one protrusion can stabilize the tubing on its pathway in particular during the cutting action and makes cutting the tubing much easier.

Preferably, the support for the tubing is at least in part formed as a tunnel through which the tubing is led. Such a tunnel can separate multiple tubing and serves as an even better stabilizer.

In a more specific embodiment of the device, the cutting region of the cutting element is disposed adjacent to support for the tubing. In this way it is ensured that the cutting procedure is carried out at the most supported part and hence the most stable portion of the tubing.

The support of the tubing preferably comprises a recess to provide a cutting region of the cutting element within the support. In such an embodiment, the tubing is most securely supported during the cutting action.

In a preferred embodiment, the tube support comprises the entry window and the exit window for defining the pathway of the tubing. In this way, the frame can be independently constructed from the exit window and entry window of the tubing, but the tubing is supported appropriately by the support from entering and leaving the device.

The frame preferably comprises a one-way stopper for stopping the mobile portion from retracting after cutting. In this way it is ensured that the cutting element is held in a certain place after cutting the tubing so that the risk of an unwanted accident is avoided. The one-way stopper can be designed releasable, i.e. that for example a stopping element holds the mobile portion and can be disconnected from the mobile portion to enable the mobile portion to be retracted in the original position.

The one-way stopper can be formed with a ramp and/or a triangle shaped section. This enables an easy slide of the mobile portion over the stopper. The frame is preferably made of a flexible and deformable material and is in particular formed as an open loop. This is a very easy structure to provide the frame and the mobile portion simultaneously and as an integral embodiment.

### BRIEF DESCRIPTION OF THE FIGURES

FIG. 1 shows an isometric view of an embodiment according to the invention;

FIG. 2 shows an isometric view of the embodiment of FIG. 1 including tubing leading through the frame;

FIG. 3 shows a front view of the embodiment of FIG. 1;

FIG. 4 shows an isometric front view of the embodiment of FIG. 1;

FIG. 5 shows an isometric section of the embodiment of FIG. 1;

FIG. 6 shows a longitudinal section of the embodiment of FIG. 1 in an open state including tubing leading through the frame;

FIG. 7 shows a longitudinal section of the embodiment of FIG. 1 in a closed state including tubing leading through the frame;

FIGS. 8a to 9b show different embodiments of the present invention concerning the placement of the support of the tubing, the cutting element and the entry window and exit window in an isometric and an side view.

### DESCRIPTION OF THE PREFERRED EMBODIMENTS

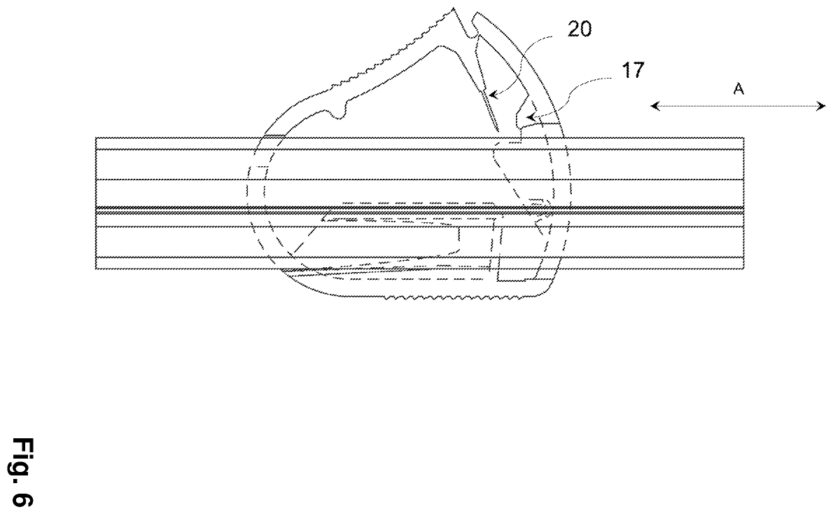

If not specifically explained otherwise, the term axial, radial and circumferential are used in the following with regard to the tubing that is accommodated by the cutting device. I.e. in FIG. 6 the axial direction goes along the longitudinal direction of the tubing from left to right (or the opposite direction), the radial direction is any direction perpendicular to the axial direction and the circumferential direction is a direction around the tubing.

A cutting device 10 comprises a frame 12, an entry window 14 via which the tubing 50 is introduced into the device 10, an exit window 16 through which the tubing 50 leaves the device 10, a mobile portion 30 and a cutting element 20. The entry and exit windows are big enough to accommodate one tubing, but preferably they are able to accommodate at least two tubings (dual or multi channel tubing).

The frame 12 is preferably made of a plastic material, in particular since the cutting device is preferably disposable for one or only a few uses. The frame is furthermore made of a deformable, in particular flexible material that has elastic characteristics, which is particularly advantageous for providing a very simple mobile portion 30.

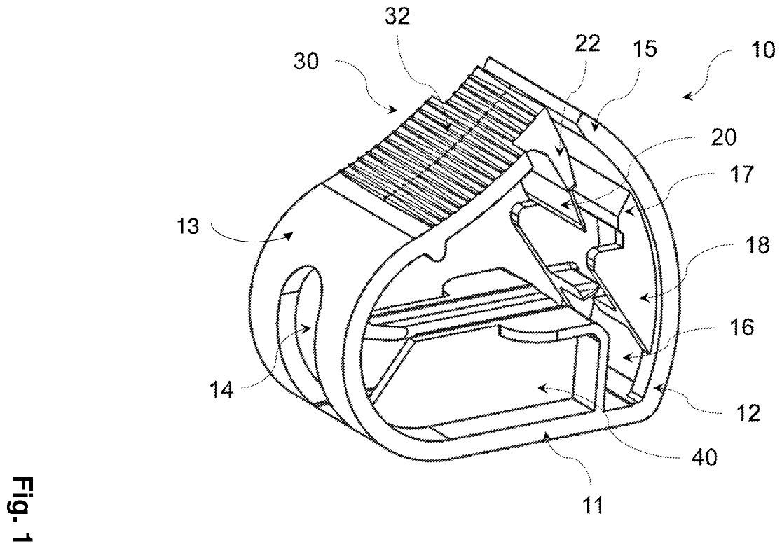

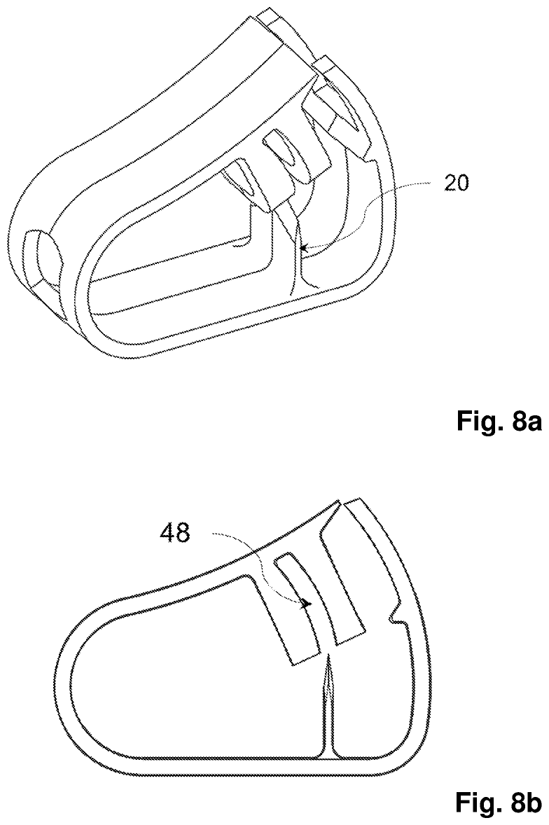

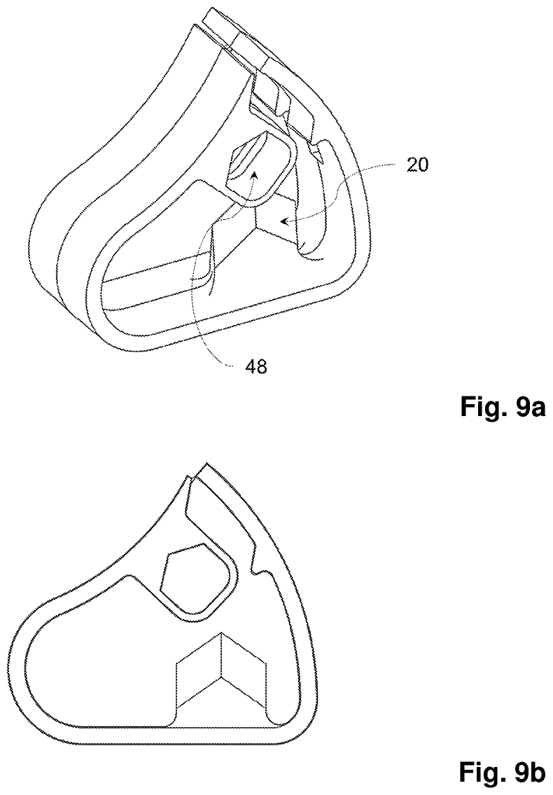

FIG. 1 shows an isometric view of the cutting device 10 according to the present invention. This is a mere example of one embodiment of the present invention and merely the relative locations of the different elements are important, but not the specific locations as mentioned below. I.e. if the cutting element is described as being on the top side of the frame and the tubing is on the bottom, they could also be located on opposite locations as shown in FIGS. 8a to 9b.

Additionally to the above mentioned features, the device shown in the embodiment in FIG. 1 comprises a support 40 for the tubing 50 and protective walls 18. Furthermore, the frame 12 is formed loop-like, i.e. it is closed like a circle, although the shape can differ (as can be seen in the figures). The frame 12 of the present embodiment has a flat bottom 11, an arcuate shaped side 13 for the entry window 14, an arcuate shaped side 15 for the exit window 16 and an inclining top surface on which the mobile portion 30 is provided. At the end of the mobile portion, the mobile portion and the arcuate shaped side 15 with the exit window 16 are touching each other, but are not connected or only with a breakable connection as a tamperproof feature to avoid accidental actuation of the cutting device. Thus, the mobile portion 30 can be moved along the inside of the arcuate shaped side 15 and pushed downwards to perform the cutting action. On top of the mobile portion 30 is a rough surface 32, for example small groove marks or ribs, which gives a tactile control when the mobile portion is pushed so as to avoid accidental slipping.

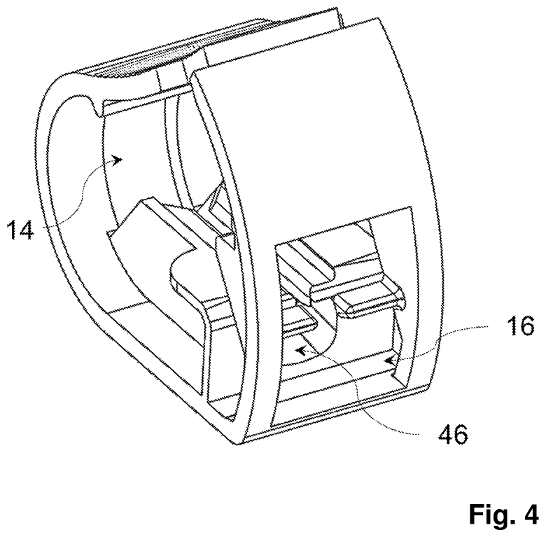

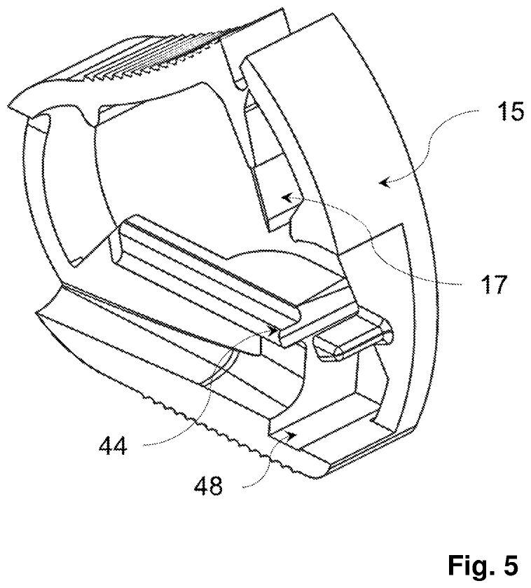

In the depicted embodiment of FIGS. 1 to 7, the cutting element 20 is formed on the mobile portion 30. However, the cutting element is arranged opposite from the path of the tubing that is defined by the entry window 14 and the exit window 16. The cutting blade 20 is arranged lateral to the pathway on which the longitudinal axis of the tubing is guided. The cutting element can be made of plastics and integrally molded into the frame. However, it is preferred that the cutting element 20 is a metal blade and is disposed in a reception 22 that is formed on the mobile portion 30. The cutting element can be glued into the reception 22, but it is also possible to that the cutting element 20 is held in the reception 22 by a simple fit. Furthermore, the cutting element can have a cutting edge that is inclined or has a triangle shape with a sharp tip in the middle (see FIGS. 8a to 9b).

On the side 15 of the frame 12 are provided two safety walls which cover the pathway on which the cutting element 20 moves in direction of the tubing 50. The safety walls can also provide stability to the tubing so that the tubing cannot evade the cutting element 20 to the side. Additionally, the side 15 that abuts against the mobile portion is preferably also flexible to enable the release of the mobile portion 30 from the stopper as described below.

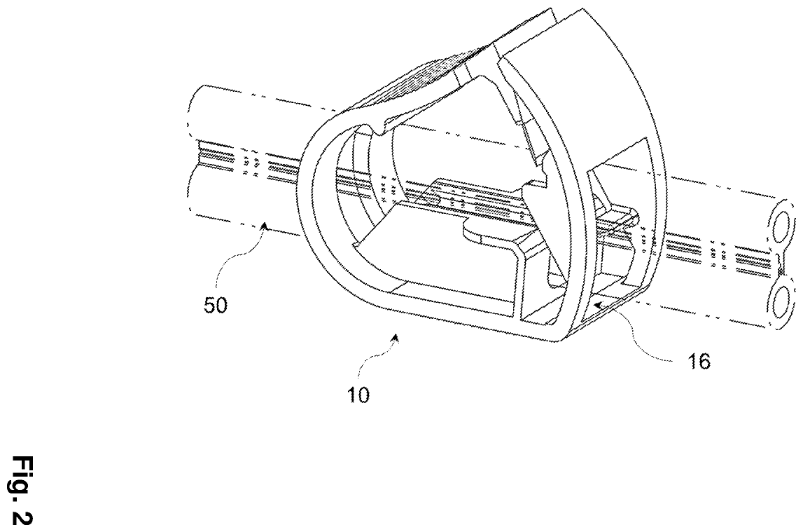

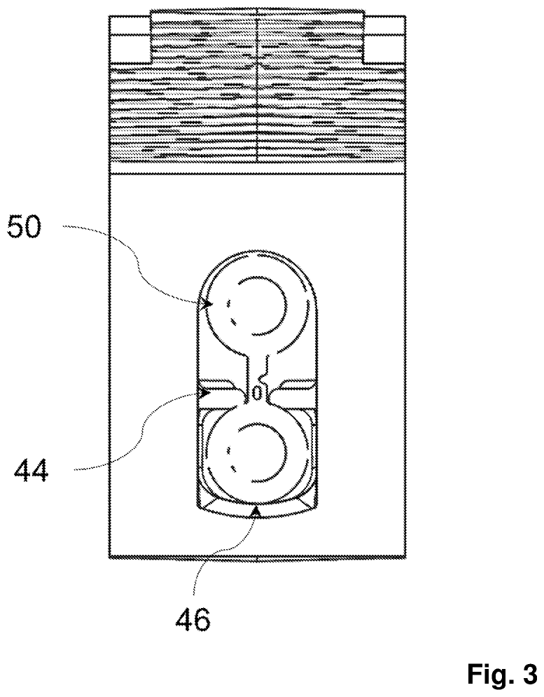

A support 40 for the tubing is arranged on the bottom of the frame. The support 40 serves to guide the tubing through the device 10 and also to stabilize the tubing in the cutting region. Generally, the support comprises at least 1 protrusion, in particular at least one protruding wall. In the embodiment that is shown in FIGS. 1 to 7, the support 40 is tunnel shaped, i.e. it comprises two side walls and a top wall which is has a slit in the middle through which the lower and the upper tubings are connected. In FIGS. 2 and 3 it is shown how the support can separate two tubings from each other. On the bottom of the support 40, there can be provided a progressive slope 46 which pushes the tubing against the cutting element. In another embodiment, the support 40 is also used as the entry window 14 and the exit window 16 (see FIGS. 9a and 9b).Furthermore, the support 40 is arranged adjacent to the region in which the cutting element 20 will cut the tubings. Preferably the support 40 comprises a groove 48 in which the cutting element will enter while or after cutting of the tubing is performed.

The frame 12 comprises a stopper 17 on the side 15 on which the mobile portion 30 is moving. The stopper serves to keep the mobile portion in the cutting position after it has been used to cut the tubing. The stopper has a cross section that is shaped to enable an easy movement for the mobile portion over the stopper, but restrict the movement of the mobile portion 30 when it is in the position after cutting. Such a shape is for example a triangle shape.

FIGS. 8a to 9b show embodiments of the present invention which differ in the placement and orientation of the tube support and the cutting element. FIGS. 8a and 8b for instance shows an embodiment in which the tube support is arranged on the mobile portion, and the cutting element is fixed on the bottom of the frame. The cutting is then carried out by pushing the tubing against the knife. In FIGS. 9a and 9b the support 40 is rotated about 90° degrees so that the frame 12 does not have entry and exit windows. Therefore, the support 40 serves as entry and exit windows.

For use, the tubing is introduced into the entry window 13 of the frame 12, is guided through the support 40 for the tubing 50 on the pathway and led out of the exit window. In case there are multiple tubings, the upper and lower tubings are guided through the respective locations on the support 40. As can be seen in FIG. 6, the device 10 can be freely moved along the tubing until the correct position is achieved (Arrow A).

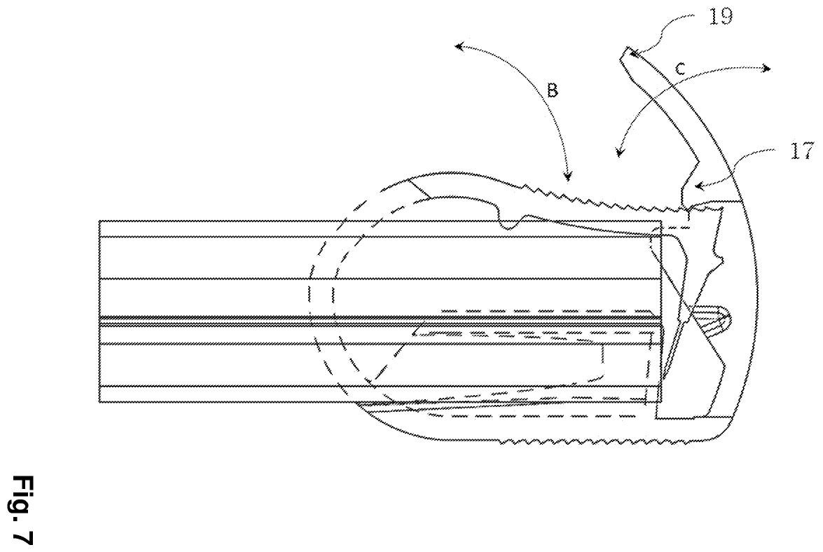

Then the mobile portion 30 is pressed down until the cutting element has completely cut the tubing 50 (see FIG. 7 Arrow B). By pressing the mobile portion down, the end of the mobile portion slides over the stopper 17 and gets hooked under the stopper. This prevents accidental opening of the cutting device. If the cutting device has to be opened again, the upper end 19 of the side 15 of the frame 12 has to be bent away from the mobile portion, thereby releasing the engagement of the stopper 17 and the mobile portion (see FIG. 7 Arrow C).

### REFERENCE LIST

device 10

frame 12

entry window side 13

entry window 14

exit window side 15

exit window 16

stopper 17

protective wall 18

upper end 19

cutting element 20

reception 22

mobile portion 30

rough surface 32

support 40

top wall 44

progressive slope 46

cutting groove 48

tubing 50

1. Device (10) for cutting tubing (50), comprising:
a frame (12) having an entry window (14) and an exit window (16) for defining a pathway of the longitudinal axis of the tubing (50) through the device (10);
a cutting element (20) arranged on the frame (12), wherein the cutting element (20) is arranged lateral and opposite to the pathway of the tubing; and
wherein at least the portion of the frame (12) is formed mobile and the cutting element (20) is arranged on or opposite to the mobile portion to enable the cutting element (20) to be pressed into the pathway of the longitudinal axis of the tubing.

2. Device (10) according to claim 1, wherein the cutting element (20) is a metal blade.

3. Device (10) according to claim 1, wherein the frame further comprises protective walls for covering the cutting element (20).

4. Device (10) according to claim 1, wherein the frame further comprises a support (40) for the tubing (50) having at least one protrusion to stabilize the tubing (50).

5. Device (10) according to claim 4, wherein the support (40) is at least in part formed as a tunnel.

6. Device (10) according to claim 4, wherein the cutting region of the cutting element (20) is disposed adjacent to the support (40).

7. Device (10) according to claim 4, wherein the support for the tubing (50) comprises a recess to provide a cutting region of the cutting element within the support (40).

8. Device (10) according to claim 4, wherein the support (40) comprises the entry window and the exit window for defining the pathway.

9. Device (10) according to claim 1, wherein the frame (12) comprises a stopper (17) for stopping the mobile portion (30) from retracting after cutting.

10. Device (10) according to claim 9, wherein the stopper (17) has a section formed as a triangle.

11. Device (10) according to claim 1, wherein the frame is made of a deformable material.
